(19) United States
(12) Patent Application Publication
(10) Pub. No.: US 2004/0131066 A1
(43) Pub. Date: Jul. 8, 2004

(54) Electronic switching circuit and method for a communication interface with cut through buffer memory

(76) Inventor: Franz-Josef Gotz, Heideck (DE)

Correspondence Address: HENRY M FEIEREISEN, LLC, 350 FIFTH AVENUE, SUITE 4714, NEW YORK, NY, 10118, US

(21) Appl. No.: 10/471,666

(22) PCT Filed: Mar. 11, 2002
(86) PCT No.: PCT/DE02/00854

(30) Foreign Application Priority Data
Mar. 22, 2001 (DE) 10114391.5
Aug. 23, 2001 (DE) 10141424.2

(51) Int. Cl. H04L 12/56

(52) U.S. Cl. 370/412; 370/395.71

(57) ABSTRACT

The invention relates to an electronic switching circuit for a scalable communications interface between a first communication connection (16) having a first transmission cycle (17) with a first length and a second communication connection (12) having a second transmission cycle (13) with a second length, and comprising a receiving list (5, 15, 19, 33) for the first transmission cycle and a sending list (6, 14, 18, 31) for the second transmission cycle, wherein an element of the sending list is assigned to a data message (20, 21, 22, 23, 24, 25, 26, 27, 28) received in accordance with the receiving list, and having a cut-through buffer memory (8, 35) for a data message received in accordance with the receiving list and a data message to be sent in accordance with the sending list.

The invention relates to an electronic switching circuit and method for a communication interface having cut-through buffer memory.

Switched communication networks are known from the state-of-the-art and operate using the store-and-forward method or the cut-through method. In the store-and-forward method an entire data packet is received from a network node and moved out of memory at the node, before a data packet is forwarded to a target port.

In the cut-through method, in contrast, an entire data packet need not first be put away into the memory of the node, before it can be forwarded. Contrary to the store-and-forward method, the received data is immediately forwarded to the target port by the cut-through method.

A communications network having nodes that operate using a cut-through method and have a cut-through buffer memory, is disclosed in U.S. Pat. No. 5,485,578.

The state-of-the-art provides many other different methods and systems for implementing communication connections between data network stations. Buss systems that enable every station to address every other station on a data network are wide spread. Furthermore, switched data networks are known wherein the so-called “point-to-point” connections are implemented, that is, one station on the switched data network can only indirectly reach any other station, through an appropriate forwarding of the transmitted data through one or more linking units.

Data networks enable the communication among multiple stations through an internet; thus the connection of individual stations with each other. Communication refers to the transmission of data between the stations. The data to be transmitted is transmitted as a data message, which means that the data is assembled into several packets and sent over the data network to the corresponding receiver in this form. For that reason they are referred to as data packets. Therefore, in general, the term data transmission is used as a synonym for the corresponding transmission of data messages or data packets.

For example the Internet itself is broken up into switched high-performance data networks, especially Ethernet networks, so that at any one time between two stations at least one server unit that is connected to both stations is switched. Each server unit can be connected to more than two stations. Each station is connected to with another station, though not directly, through at least one server unit. In particular, stations have operated computers, stored-program control systems (SPS) or other types of machines that exchange data with other machines, for example.

In distributed automation systems, for example in the area of machine control, designated data must come to a designated station at a designated time for it to be processed by the receiver. This is referred to as real-time-critical data, or rather data operations, wherein an untimely arrival of data at the designated place leads to undesired results for the station. According to the SERCOS Technical Abstract (http://www.sercos.org/english/index.htm) for interface IEC 61491, EN61491, a successful real-time-critical data operation can be implemented in distributed automation systems in the prescribed manner.

Likewise, it is known in the state of the art to employ a synchronous-clock communications system in one such automation system having an “equal-distance” characteristic. Hereafter, a system is assumed to have at least two stations that are connected for the purpose of reciprocal exchange of data, or rather the reciprocal transmission of data to each other.

This results in cyclical data exchange in equal-length communication cycles that are prescribed by the communications clock used by the system. Stations are, for example, centralized automation apparatus; programming, planning or control apparatus; peripheral apparatus such as, for example: input and output assemblies, drivers, actuators, sensors, stored-program controller systems (SPS) or other control units, computers or machines that exchange electronic data with other machines, especially those that process data from other machines. Hereafter, control units are understood to be limiters or drivers of any sort. Among the data networks are bus systems such as field bus, process field bus, Ethernet, industrial Ethernet, FireWire, or even PC internal bus systems (PCI), etc.

Today, in general, automation components (for example controllers, drivers . . . ) access a cyclically-timed communication system through an interface. One level of automation component operation, “fast-cycle,” is synchronized with the communications cycle, for example: a controller's position management, or a driver's torque management, etc., is synchronized with the communications cycle. Thus they are set to the communications clock. Other, low-performance “slow-cycle” algorithms of the automation devices, for example temperature control, can only communicate with other devices such as binary switches for blowers, pumps, etc., using this communications clock, even though a longer cycle time would be adequate. By using only one communications clock for transmitting all information in a system, they make heavy demands on the bandwidth of the communications channel.

System components using only one communications system, or rather one communication cycle, the “fast-cycle”, for communication with each process or each automation level, wherein all relevant information is transmitted using that clock, are known in the state of the art. For example, data that are only needed in the slow-cycle can be staggered so as to limit their bandwidth requirement by using auxiliary protocols. That means an additional software expense in the automation components. Furthermore, the bandwidth of the bus as well as the shortest possible communication cycle for the entire system is determined by the lowest-performance components.

The invention is based on the object to provide an improved method and an improved electronic switching circuit for a communication interface as well as corresponding computer software.

The object which the invention is based upon is attained by the features of the respective independent claims.

The invention permits a single communication interface to be implemented between cyclically timed communication connections having different performance specifications. For example in an automation system, the invention makes it possible for the characteristics of each application to be adjusted, to operate communication connections having different performance specifications. Using the invention a low-performance interface can be implemented for slow input and output assemblies, whereby they can communicate with the assigned operational levels in the controller through the corresponding interface for example.

A particular advantage of the invention is that it permits the joining of data messages from different communication connections having the same transmission rates and synchronous communication cycles at the level of a linking node, without a higher logical level application program being needed for that. In particular this is advantageous for a communications switch, a so-called ASIC switch, whereby this communications switch can include multiple separate ports for different communication connections.

A further particular advantage of the invention is that it makes possible a more consistent exchange of real-time data possible in a synchronous communications system made up of different sub-networks that have respective different transmission rates and/or communication cycles. It is crucial for a consistent transmission of real-time data, that it be assigned each time to a respective given communication cycle, and that is also true across the communication interface between individual sub-networks. Such a fixed assignment of real-time data to given communication cycles across the boundaries of sub-networks is made possible by the invention.

In accordance with the invention consistent data exchanges are provided through a cut-through buffer memory, that is to say, the data is immediately forwarded from the receiving port to the relevant sending port.

The invention is also advantageous in that it allows a communications interface to be provided between a high-performance and a low-performance, as well as from a low-performance to a high-performance communications connection. A high-performance communication connection is understood to mean a communication connection over which data is transmitted in each transmission cycle. A low-performance communication connection is understood to mean a communication connection over which data is not transmitted in each transmission cycle.

Whenever a data message is received from a high-performance communication connection, this data message is forwarded to a low-performance communication connection when a transmission cycle of the low-performance communication connection begins essentially simultaneously with the receipt of the data message.

Typically, the same data message, the sampling value from a sensor for example, is repeatedly transmitted over the high-performance communication connection within a short time interval, so that the useful information of the individual data messages only varies slightly because of a relatively high frequency sampling. If when a subsequent data message is received, the low-performance communication connection finds itself still in the preceding transmission cycle, then this subsequent data message is ignored by the communications interface.

This is continued, until a data message is again received on the high-performance communication connection, and this receipt occurs essentially simultaneously with the beginning of a transmission cycle on the low-performance communication connection. This procedure produces an under sampling in the communications interface.

On the other hand, if a data message is received over the low-performance communication connection, then this data message is immediately forwarded to the high-performance communication connection whenever a transmission cycle of the high-performance communication connection begins essentially simultaneously with the receipt of the data message from the low-performance communication connection. In subsequent transmission cycles of the high-performance communication connection it can call for the corresponding sending list, so that corresponding further data messages are sent over the high-performance communication connection, because a device that expects the corresponding data messages at the timing rate provided by transmission cycle of the high-performance communication connection is controlled by such receipts, for example.

In that case, the data message received only once from the interface can be repeatedly transmitted in consecutive transmission cycles of the high-performance communication connection during the transmission cycle of the low-performance communication connection, or else a repeated transmission of the data message received only once can be sent as a message equivalent designated as invalid, instead. Either a gap in the sending list or a gap in the receiving list of the corresponding port can be traversed.

Interface scalability is provided this way, that is, in coupling different communication connections with each other it can produce either an over- or under-sampling. It is especially advantageous that such a coupling is possible for real-time data.

It is particularly advantageous, furthermore, that only one standard communication interface has to be implemented in a linking node and that no additional instance of data copying is necessary between different communication interfaces.

A further advantage of the invention is that it allows an automation system to be realized that includes sub-networks having different performance specifications, for use by and in packaging machines, presses, plastic-coating machines, textile machines, printing machines, machine tools, robots, conveyor systems, wood processing machines, glass processing machines, ceramics processing machines as well as hoists, in particular.

A preferred embodiment of the invention is now explained in greater detail with reference to the drawings. It is shown in:

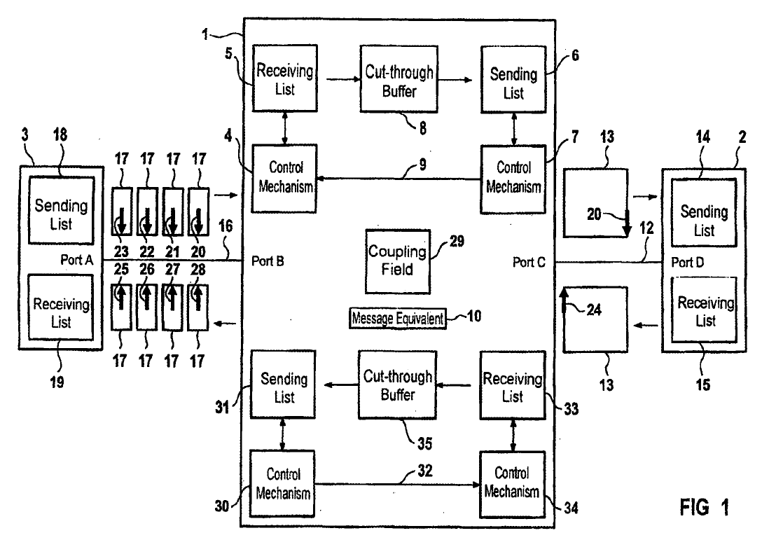

FIG. 1 a block diagram of an embodiment of an electronic switching circuit and corresponding communication connections between two stations of networks having different performance specifications in accordance with the invention;

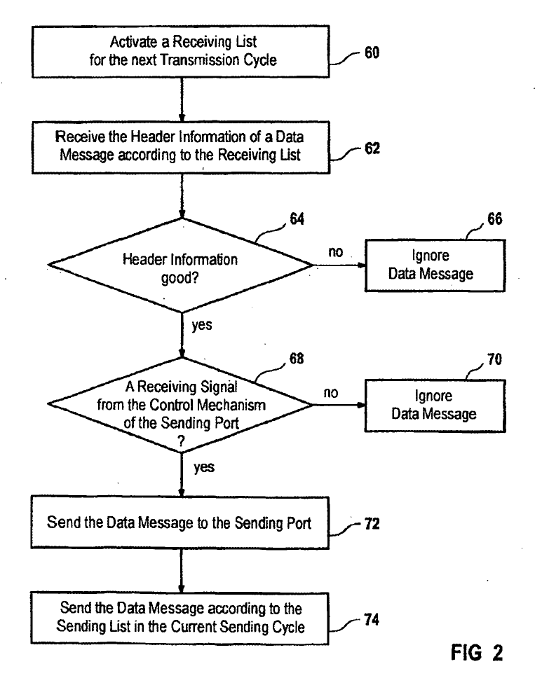

FIG. 2 a flow diagram of a preferred embodiment of a method for the receiving and forwarding of data messages in accordance with the invention;

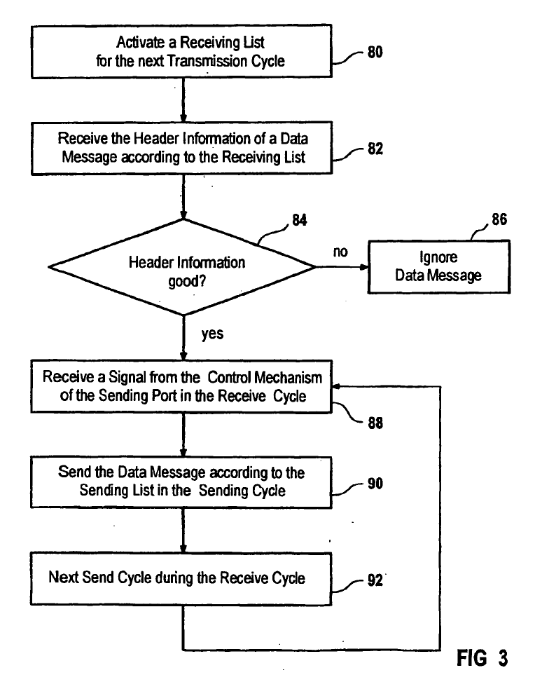

FIG. 3 a flow diagram of a preferred embodiment for sending a data message from a low-performance to a higher-performance network;

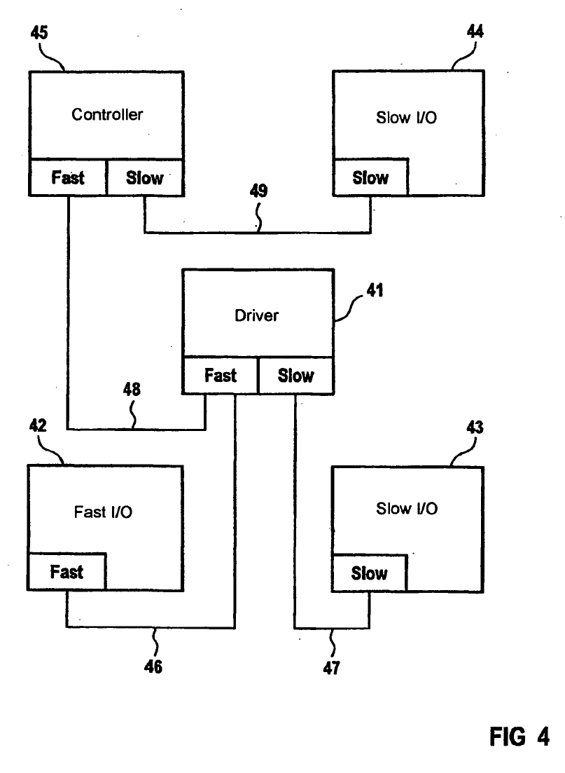

FIG. 4 a preferred embodiment of an automation system in accordance with the invention;

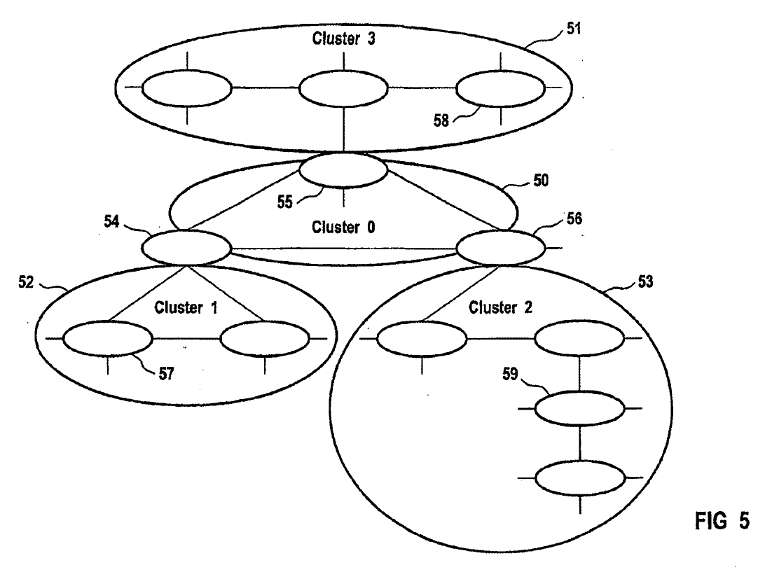

FIG. 5 a preferred embodiment of an automation system with sub-networks having different performance specifications.

FIG. 1 shows an electronic switching circuit 1 that serves as the linking node between the nodes 2 and 3. The linking node 1 has the two communications ports, port B and port C.

A receiving list 5 is assigned to Port B. The receiving list 5 determines the data messages that will be received at port B at different time points from other, different nodes of the communications system. The time point and the address of the data messages are determined in advance in this way; and it changes solely for each of the data messages that carry operational data.

Port C has an assigned sending list 6 that determines which data message is to be sent out from this Port C of the linking node 1 at which point in time to which receiver.

The linking node 1 also has another cut-through buffer 8 for the receiving and forwarding of a data message. The a cut-through buffer 8 serves as a receiving buffer as well; and a sending buffer is made unnecessary by the use of a cut-through method. The linking node 1 also has a control mechanism 4 for the receiving list 5 and a control mechanism 7 for the sending list 6.

Control mechanism 4 activates receiving list 5 at the beginning of a transmission cycle 17, and control mechanism 7 activates sending list 6 at the beginning of a transmission cycle 13. As soon as the transmission cycle 13 begins, a signal 9 is provided by the control mechanism 7 to the control mechanism 4. This notifies the control mechanism 4 that a data message received essentially simultaneously with the transmission cycle just beginning, can be forwarded immediately through the cut-through buffer 8 of port C to the receiver, that is, the node 2 for example.

The linking node 1 is connected over a communication connection to the node 2. It communicates through the communication connection 12 with a low-performance connection having a transmission cycle 13, also referred to as a framework or “frame” of a communication cycle.

The communication connection 12 connects port C with port D of the node 2. A sending list 14 and a receiving list 15 are assigned to port D which define the synchronous transmission of data messages, that is, transmission of data messages across the communication connection 12.

Correspondingly, the port B of the linking node 1 is connected to a port A of the node 3 by a communication connection 16, the communication connection 16 providing a connection having a relatively high data rate and a relatively short transmission cycle 17.

In port A of the node 3, on the other hand, there is a sending list 18 and a receiving list 19 for the synchronous transmission of data messages to and from node 3, respectively.

Communication flows over the communication connections 12 and 16 in cyclically-repeated transmission cycles 13 and 17, respectively, which themselves can be divided into respective time slots. During a respective one of the transmission cycles 13 or 17, the corresponding receiving and sending lists are employed so that different data messages are assigned to the relevant time slots in a transmission cycle.

In the example seen in FIG. 1, four time-consecutive transmission cycles 17 are shown in which one or more data messages are transmitted at a time. For the sake of clarity, only one data message 20, 21, 22 or 23, respectively, is shown for each transmission cycle 17 in FIG. 1.

Basically, the communication connections 12 and 16 need to be synchronized with each other in the linking node 1 to make use of the “cut-through” method, that is to say, the beginning of the transmission cycles 13 and 17 can have no phase shift. Likewise, the length of the of the transmission cycles 13 and 17 can not have just any value, rather the lengths must either be the same or have a whole-number relationship to one another.

In a second alternative example, the node 2 sends a data message 24 according to this sending list 14 in the transmission cycle 17 over the communication connection 12 from this port D to port C of the linking node 1. The data message 24 is received by port C of the linking node 1 according to its receiving list 33 and, when the control mechanism 34 of receiving list 33 receives a corresponding signal from the control mechanism 30 of sending list 31 essentially simultaneously with the receipt of the data message 24, is forwarded through the cut-through buffer 35 as a transmission to port B.

Then in the next transmission cycles 17, the linking node 1 sends the data messages 25, 26, 27, and 28, respectively, from port B according to this sending list 31. It can happen in this way because a copy of the data message 24 acts as the data messages 25 to 28, respectively. The requirements of the receiving list 19, which anticipates a data message in each data slot of the transmission cycle 17, are satisfied in this way.

The storing of a data-message equivalent that carries no useful information in the memory 10 is an alternative possibility. In that case, only one of the messages 25 to 28 is a copy of the message 24, for example the data message 25. This process can be carried out under the supervision of the control mechanism 30, for instance.

Altogether, therefore, for an n-fold transmission of a data message from node 3, a four-fold transmission for example, this data message is sent from the node 1 to the node 2 “m” times wherein m<n. Preferably m=1, as in the observed example.

On the other hand, in an n-fold transmission over the low-performance communication connections 2, this data message is either repeated m-times, that is to say a four-fold repetition of one single transmission, as in the referenced example, or else the data message sent is transmitted only once and it is followed by an additional transmission of m−1 message equivalents.

The linking node 1, furthermore, has a coupling field 29 over which communication connections between ports B and C, as well as with other ports the linking node 1 not shown in FIG. 1, can be made as needed.

The linking node 1 itself can also be an integral part of an automation device.

FIG. 2 shows a corresponding flow diagram for the receipt and the forwarding of a data message. In step 60, the receiving list for the subsequent transmission cycle is first activated at the receiving port.

After that a data message is received in step 62; in fact, the so-called header information is received first. This header information is tested for validity in the step 64. In the event that the result of this testing based on the received header information, the calculation of a proof sum or the application of a similar method, for example, shows that the data message sent is or rather was not valid, this data message is ignored in step 66.

When on the contrary the header information is valid, whether or not a signal has been received from the control mechanism of the sending port is tested in step 68. The receipt of such a signal indicates that a transmission cycle at the sending port is just beginning. When that is not the case, the data message is ignored in step 70. When the opposite is the case, that is, when a sending transmission cycle is just beginning, the data message is transferred from the cut-through buffer to the sending port in step 72 and in step 74 it is sent out from there in the current sending transmission cycle according to the sending list.

FIG. 3 shows an alternative embodiment of this method, with particular regard to the receipt of a data message from a low-performance communication connection for forwarding over a high-performance communication connection.

In step 80 the receiving list is again activated for the next receiving cycle. The subsequent steps 82, 84 and, if needed, 86 operate analogously to the corresponding steps 62, 64 and if needed, 66 in the flow diagram of FIG. 2.

When the test in step 84 is successful, because the header is valid, the data message is sent out in the next synchronous transmission cycle in step 90, provided that a corresponding signal has been previously received from the control mechanism of the sending port during the receiving cycle of the receiving port in step 88.

In step 92 the next sending cycle of the sending port begins while the receiving cycle of the receiving port still continues. A signal from the control mechanism of the sending port is again received by the receiving port, after which a new sending transmission cycle of the sending port begins in step 88. Thereafter the data message is again sent in step 90. This succession of steps 88, 90, 92 is repeated, that is, the data message is repeatedly sent, so long as receiving cycle lasts at the receiving port.

FIG. 4 shows an explanatory example of an automation system having nodes 41, 42, 43, 44 and 45. A driver acts through the node 41, which includes a linking node having both “fast” and “slow” ports. The “fast” port corresponds to port B and the “slow” port corresponds to port C in the linking node 1, in FIG. 1.

The “fast” port of the node 41 is connected to the “fast” port of node 42, corresponding to port A of the node 3 in FIG. 1. The circuit connecting the “fast” ports of the nodes 41 and 42 acts as a high-performance communication connection 46, corresponding to the communication connection 16 of FIG. 1.

The other port of the node 41, the “slow” port, is connected over a low-performance communication connection 47 with a “slow” port of the node 43, corresponding to the communication connection 12 and the port D of FIG. 1, respectively.

Furthermore, an additional “fast” port is connected to a corresponding “fast” port of node 45, a controller for example, over a high-performance communication connection 48. Node 45 has a “slow” port that is connected over a low-performance communication connection 49 with a respective “slow” port of the node 44. The node 45 includes also a linking node of the type shown in FIG. 1. The node 44 has a structure that corresponds to that of node 2 in FIG. 1.

Therefore, for example, it is possible for a data message to be transmitted between node 42 and node 44 in the automation system of FIG. 4, even though the transmission must traverse three communication connections having respective different characteristics.

This can also be used for the linking of different sub-networks, as is explained in further detail with reference to FIG. 5:

The automation system of FIG. 5 has different sub-networks 50, 51, 52 and 53. The sub-networks 50 to 53 have respective different communications systems with synchronous transmission cycles and the same data rates.

The corresponding communications system provides communication for the nodes of one sub-network among one another. However, it can also produce a communication across the boundaries between sub-networks. For this, the nodes 54, 55 and 56 of the sub-network 50 and, in fact, the corresponding linking node 1 of FIG. 1, for example, are constructed as linking nodes.

For instance node 57 of sub-network 52 and node 58 of sub-network 51 can communicate with each other, even though sub-networks 51 and 52 have different transmission cycles and /or different data rates. Accordingly, node 59 of sub-network 53 can communicate with the node 57, the node 58 or one of the linking nodes 54 to 56 as well. This allows different already-existing automation systems to network with each other as an integrated system without the components of the existing systems having to be changed.

Preferably an industrial Ethernet is employed as the communications system for the individual sub-networks, preferably an isochronous real-time Ethernet or a fast real-time Ethernet having respective different transmission cycles, that is, different isochronous cycles and/or different data rates. The length of the different transmission cycles can be 500 ms, 10 ms, and 1 ms, for example.

In summary, the invention pertains to a method and an electronic switching circuit for a scalable communication interface between a first communication connection having a first transmission cycle with a first length and a second communication connection having a second transmission cycle 13 with a second length, wherein the first and the second transmission cycles are synchronous and the first and second lengths are the same or have a whole-number relationship to each other, and having a receiving list for the first transmission cycle and a sending list for the second transmission cycle, wherein a data message received in accordance with the receiving list is assigned to an element of the sending list, and having a cut-through buffer memory for a data message received in accordance with the receiving list and data message sent in accordance with the sending list.

1. Electronic switching circuit for a communication interface between a first communication connection (16) having a first transmission cycle (17) with a first length and a second communication connection (12) having a second transmission cycle (13) with a second length, wherein the first and the second transmission cycle synchronous with each other and the first and second lengths are the same or have a whole number relationship to each other, having a receiving list (5, 15, 19, 33) for the first transmission cycle and a sending list (6, 14, 18, 31) for the second transmission cycle, wherein a data message (20, 21, 22, 23, 24, 25, 26, 27, 28) received according to the receiving list is assigned to an element of the sending list, and having a buffer memory (8, 15) for a data message received in accordance with the receiving list and data message sent in accordance with the sending list.

2. Electronic switching circuit according to claim 1 having means (4, 7, 9, 30, 32, 34) for forwarding the data messages from the buffer memory to the second communication connection.

3. Electronic switching circuit according to claim 1 or 2 having a first control mechanism (4, 34) for the receiving list and a second control mechanism (7, 30) for the sending list, wherein the second control mechanism is adapted to provide a signal (9, 32) to the first control mechanism when the second communication cycle begins.

4. Electronic switching circuit according to claim 1, 2 or 3 having means for testing header information in a data message and means for forwarding the data message to the second communication connection as soon as the header information is verified.

5. Electronic switching circuit according to one of the preceding claims 1 to 4, wherein first and/or second communication connections are bidirectional and each of the bidirectional connections is assigned a sending list and a receiving list, respectively.

6. Electronic switching circuit according to one of the preceding claims 1 to 5, wherein real-time data is communicated by the data message.

7. Electronic switching circuit according to one of the preceding claims 1 to 6, wherein the first and second communication connections have an equal length characteristic.

8. Electronic switching circuit according to one of the preceding claims 1 to 7, wherein the first and second communication connections communicate over an industrial Ethernet, in particular an isochronous real-time Ethernet or a real-time fast Ethernet (RTF).

9. Electronic switching circuit according to one of the preceding claims 1 to 8 having multiple input and/or output ports to which a receiving and/or sending list is assigned, respectively, and having a coupling field (29) for the linking of one or more other ports.

10. Automation system having multiple components (41, 42, 43, 44, 45) that are connected with each other by communication connections (46, 47, 48, 49) wherein each of the components has an electronic switching circuit of one of the preceding claims 1 to 9.

11. Automation system having at least one first sub-network (50) with first communication connections and having at least one second sub-network (51, 52, 53) with second communication connections and having at least one linking node (54, 55, 56) between the first and second sub-networks with an electronic switching circuit of one of the preceding claims 1 to 9.

12. Automation system according to claim 10 or 11 having multiple linking nodes that are connected to each other through a third sub-network.

13. Automation system according to claim 10, 11 or 12, wherein the different sub-networks have different transmission cycles and/or transmission rates.

14. Method for managing a communication interface between a first communication connection having a first transmission cycle with a first length and a second communication connection having a second transmission cycle with a second length, wherein the first and the second transmission cycles are synchronous with one another and the first and second lengths are the same or have a whole number relationship to each other, having the following steps:
a. the receipt of a data message according to one of the first transmission cycles of the assigned receiving list,
b. the storing the data message in a buffer memory,
c. the transmission of the data message according to one of the first transmission cycles of the assigned sending list.

15. Method according to claim 14, wherein a control mechanism of the sending list provides a signal to the control mechanism of the receiving list when the second transmission cycle begins.

16. Method according to claim 14 or 15, wherein real-time data is communicated by the data message.

17. Method according to one of the preceding claims 14 to 16, wherein the first and second communication connections have an equal-length characteristic.

18. Method according to one of the preceding claims 14 to 17, wherein the first and second communication connections communicate over an industrial Ethernet, in particular an isochronous real-time Ethernet or a real-time fast Ethernet.

19. Method according to one of the preceding claims 14 to 18, wherein multiple input and/or output ports to which a respective receiving and/or sending list is assigned, respectively, are linked through a coupling field.

20. Method according to one of the preceding claims 14 to 19, wherein the first and second communication cycles have no phase shift.

21. Computer program product having means for carrying out a method according to one of the preceding claims 14 to 20, wherein the computer program means is carried out by an electronic switching circuit and/or an automation system.
